(19) United States
(12) Patent Application Publication
(10) Pub. No.: US 2026/0279945 A1
(43) Pub. Date: Sep. 17, 2026

(54) Adaptive Flame-Retardant Cooling Interface and Method for Fabricating the Same

(71) Applicant: City University of Hong Kong, Hong Kong (HK)

(72) Inventors: Wei WU, Hong Kong (HK); Zengguang SUI, Hong Kong (HK)

(21) Appl. No.: 19/557,181

(22) Filed: Mar. 5, 2026

Related U.S. Application Data
(60) Provisional application No. 63/769,792, filed on Mar. 11, 2025.

(51) Int. Cl. H01M 10/613; A62C 3/16; H01M 10/653; H01M 10/6569

(52) U.S. Cl. CPC H01M 10/613; A62C 3/16; H01M 10/653; H01M 10/6569

(57) ABSTRACT

The present invention provides an adaptive flame-retardant cooling interface comprising a thermal conductive film, a porous membrane, an array of evaporative pads accommodated compartments of a supporting frame positioned between the thermal conductive film and the porous membrane. The adaptive flame-retardant cooling interface is operable at a cooling state and a restoration state. At the cooling state, the thermal conductive film is configurable to transfer heat from a heat source to the array of evaporative pads to increase water vapor pressure in the evaporation pads, and the array of evaporative pads is configurable to desorb water vapor out to ambient environment through the porous membrane. When the adaptive flame-retardant cooling interface is attached to a cooler object, the array of evaporative pads is configurable to adsorb water vapor from ambient environment through the porous membrane such that a cooling capacity of the adaptive flame-retardant cooling interface is restored.

### CROSS-REFERENCE TO RELATED APPLICATIONS

The present application claims priority from the United States Provisional Patent Application No. 63/769,792 filed 11 Mar., 2025, and the disclosure of which is incorporated herein by reference in its entirety.

### FIELD OF THE INVENTION

The present invention generally relates to battery thermal management technology. More specifically the present invention relates to an adaptive flame-retardant cooling membrane for battery thermal management.

### BACKGROUND OF THE INVENTION

High-capacity rechargeable lithium-ion batteries (LIBs), as state-of-the-art battery technology, play a vital role in the ongoing transition from fossil fuels to renewable energy. Recently, the use of LIBs for consumer electronics, grid-scale energy storage, and transportation electrification has been steadily growing due to their high energy density, long cycle lifespan, and low self-discharge rate. However, LIBs are sensitive to operating temperatures. Poor performance caused by extreme temperatures, such as the inevitable rapid temperature increases during high-rate charging and discharging processes, severely hinders their widespread application. High temperatures can significantly degrade the reliability and lifespan of LIBs, leading to increased replacement costs. Even worse, elevated temperatures raise the risk of thermal runaway, potentially triggering an uncontrolled chain reaction of thermal runaway that can result in fires and explosions if effective thermal protection is not implemented. Therefore, designing an efficient and reliable battery thermal management system (BTMS) is essential to maintain battery temperature within a safe range.

According to energy consumption, there are two main types of BTMSs, including active and passive cooling. Active cooling strategies, such as forced air or liquid cooling, provide effective cooling while suffering from additional energy consumption, bulk volume, and complex auxiliary accessories. In contrast, passive BTMSs are increasingly attractive due to their electricity-free consumption, high compactness, and low maintenance costs.

Water evaporation from hygroscopic materials has emerged as a promising solution for achieving high-efficiency and ultra-compact passive BTMS due to its high endothermic capacity (> 2000 J/g). Hydrogels and metal-organic frameworks (MOFs) are commonly employed as hygroscopic materials due to their high water-sorption capacities and fast kinetics. However, in practical applications, these hygroscopic materials are typically exposed to the environment without adequate protection, leading to increased risks of leakage and pollution during long-term operation. For hydrogel-based cooling strategies, the inevitable deformation of hydrogels during water evaporation poses challenges to reliability and stability. Meanwhile, the flammability of the hydrogel materials also increases the risk of thermal runaway propagation once the water has fully evaporated. While MOFs are favored for their fast water-sorption kinetics, their large-scale applications are hindered by extremely high costs (> 100000 USD/kg), weak adhesion, and complex synthesis processes.

### SUMMARY OF THE INVENTION

In order to address above challenges, the present invention provides a novel adaptive hygroscopic cooling membrane as a major advancement towards electricity-free, high-flux, flame-retardant, and high-reliability battery thermal management.

In accordance with one aspect of the present invention, an adaptive flame-retardant cooling interface is provided. The interface comprises: a thermal conductive film; a porous membrane; and an array of evaporative pads accommodated respectively in an array of compartments of a supporting frame positioned between the thermal conductive film and the porous membrane. The adaptive flame-retardant cooling interface is operable at a cooling state and a restoration state. At the cooling state, the thermal conductive film is configurable to transfer heat from a heat source to the array of evaporative pads to increase water vapor pressure in the evaporation pads, and the array of evaporative pads is configurable to desorb water vapor out to ambient environment through the porous membrane. At the restoration state, the array of evaporative pads is configurable to adsorb water vapor from ambient environment through the porous membrane such that a cooling capacity of the adaptive flame-retardant cooling interface is restored.

In accordance with one aspect of the present invention, a method is provided for fabricating the adaptive flame-retardant cooling interface. The method comprises: mixing a solution of high thermal conductive nanomaterial and a solution of hygroscopic materials to form a homogenous mixture via magnetic stirring; immersing a porous wicking material in the homogenous mixture to form a thermal conductive hygroscopic composite; attaching a high thermal conductive film on a bottom surface of the supporting frame to form an array of compartments within the supporting frame; applying the thermal conductive hygroscopic composite in the array of compartments within the supporting frame to form an array of evaporative pads; and attaching a porous membrane on a top surface of the supporting frame such that the array of evaporative pads is encapsulated within the supporting frame.

In one embodiment, the thermal conductive film is a thermal conductive polymer film or a polymer matrix film loaded with thermally conductive fillers.

In one embodiment, the supporting frame is made of copper and has anti-corrosion graphene coating.

In one embodiment, each evaporative pad is a mixture of a flame-retardant porous wicking material, a hygroscopic material and a high thermal conductive nanomaterial.

In one embodiment, the porous wicking material is active carbon fiber.

In one embodiment, the hygroscopic material is a metal-organic framework, a water–salt solution, or a water–ionic liquid solution.

In one embodiment, the high thermal conductive nanomaterial is made of a graphene oxide, carbon nanotubes, a metal oxide, a metal nitride, or a metal carbide.

In one embodiment, the porous membrane is made of polyethylene (PE), polypropylene (PP), polytetrafluoroethylene (PTFE), polyvinylidene fluoride (PVDF), or combinations thereof.

The cooling membrane relies on water evaporation from the hygroscopic materials to prevent LIBs from overheating. Active carbon fiber (ACF) used in the cooling membrane shows a uniform groove texture on the surface of each fiber, which enhances the attachment of hygroscopic materials, thereby improving the heat and mass transfer performance. Meanwhile, the ACF is highly hydrophilic and flame-retardant, which prevents a non-uniform solution distribution caused by gravity and thermal runaway propagation. The present invention is therefore significant for developing efficient, flame-retardant, economic and reliable passive thermal management technologies to improve LIBs performance and reliability in practice.

The provided adaptive flame-retardant cooling interface can achieve electricity-free, high-flux, and high-reliability thermal management due to the following advantages: (1) The water desorption process involving large vaporization enthalpy yields high cooling performance without electricity consumption; (2) The high matrix porosity and strong hygroscopicity of porous wicking material enable the cooling membrane to provide outstanding sorption kinetics and uniform temperature distribution; (3) The porous wicking material features excellent flame retardancy to prevent thermal runaway propagation; (4) Doped high thermal conductive nanomaterial is conducive to forming a more efficient heat transfer network, improving the thermal conductivity of the cooling membrane; and (5) The module structure is simple that can be produced via a facile fabrication, maintaining the high reliability and low capital cost.

### BRIEF DESCRIPTION OF THE DRAWINGS

Embodiments of the invention are described in more details hereinafter with reference to the drawings, in which:

FIG. 1A illustrates an adaptive flame-retardant cooling interface in accordance with one embodiment of the present invention; and FIG. 1B is an exploded view of the adaptive flame-retardant cooling interface.

FIG. 2 an exploded view illustrating how a LIB is wrapped by the adaptive flame-retardant cooling interface in accordance with one embodiment of the present invention.

FIG. 3 illustrate a process flow of fabrication method of the adaptive flame-retardant cooling interface in accordance with one embodiment of the present invention.

FIG. 4 illustrates working principle of the adaptive flame-retardant cooling membrane at high charging/discharging rates.

FIG. 5 illustrates working principle of the adaptive flame-retardant cooling membrane at low charging/discharging rates or off hours.

FIGS. 6A to 6E illustrate demonstration of the cooling membrane to cool the commercial LIB (RH = 60% and T amb = 25° C): FIG. 6A shows temperature evolution of the LIBs with and without the cooling membrane at a discharging rate of 3C; FIG. 6B shows temperature evolution of the LIBs with and without the cooling membrane at a discharging rate of 4C; FIG. 6C shows IR images of the LIB with the cooling membrane over time; FIG. 6D shows comparison of experimental and simulation results for the LIB with the cooling membrane at a discharging rate of 4C; and FIG. 6E shows Simulated temperature contours at the cross section (black dashed lines in FIG. 6C). The scale factor is 0.5 in the x direction to show the contours more clearly.

FIGS. 7A to 7C illustrate cyclic performance demonstration on the 3.7 V/12 Ah LIB (RH = 65% and T amb = 25° C): FIG. 7A shows temperature evolution of the LIBs with and without the LiCl/GO@ACF membrane at a discharging-charging rate of 3.5C in 10 cycles. FIG. 7B shows peak temperature difference between the LIBs with and without the LiCl/GO@ACF membrane. FIG. 7C shows battery capacity decay with and without the LiCl/GO@ACF membrane at a cyclic discharging-charging rate of 4C.

FIG. 8 is a photograph showing the fire resistance property of the LiCl/GO@ACF. The insert shows that the paper origami dinosaur is flammable.

### DETAILED DESCRIPTION

In the following description, details of the present invention are set forth as preferred embodiments. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

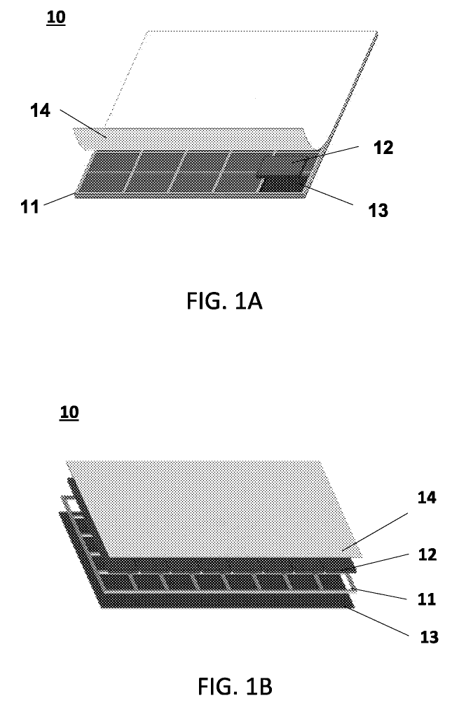

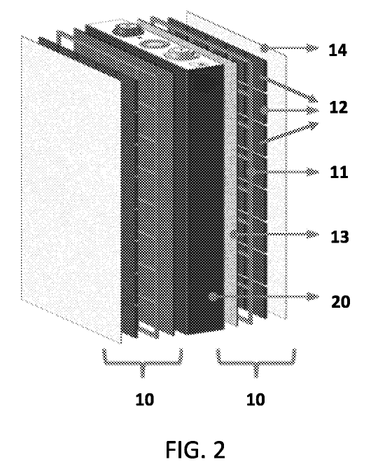

FIGS. 1A and 1B illustrate an adaptive flame-retardant cooling interface 10 in accordance with one embodiment of the present invention. FIG. 2 is an exploded view illustrating how a LIB 20 is wrapped by the adaptive flame-retardant cooling interface 10 for high-flux passive thermal management.

As shown, the cooling interface 10 comprises a supporting frame 11 having an array of compartments; an array of evaporative pads 12 accommodated respectively in the array of compartments of supporting frame 11; a thermal conductive film 13 attached on a bottom surface of the supporting frame and in contact with a first side of the array of evaporative pads 12; and a porous membrane 14 attached on a top surface of the supporting frame 11 and in contact with a second side of the array of evaporative pads 12.

In some embodiments, the thermal conductive film 13 may be made of anti-corrosion material and configured to transfer the heat generated from the LIB to the evaporative pads. The supporting frame 11 may be made of anti-corrosion metal walls as fins to facilitate the heat transfer.

The evaporative pads 12 consists of flame-retardant porous wicking material, hygroscopic material, and high thermal conductive nanomaterial. More specifically, the evaporative pads may be formed by immersing a flame-retardant porous wicking material in to a hygroscopic material (e.g., LiCl solution and/or LiBr solution) doped high thermal conductive nanomaterial (e.g., nanoparticles). The flame-retardant porous wicking material absorbs the hygroscopic material doped with high thermal conductive nanomaterial to form the evaporative pads. The porous wicking material shows a high matrix porosity, which enhances the attachment of hygroscopic materials, thereby improving the heat and mass transfer performance. Meanwhile, the porous wicking material is highly hydrophilic and flame-retardant, which prevents a non-uniform temperature distribution caused by gravity and thermal runaway propagation. Doped high thermal conductive nanomaterial is conducive to forming a more efficient heat transfer network, improving the thermal conductivity of the cooling membrane. In other words, the porous wicking material confines the hygroscopic material (H₂O/absorbent mixtures) in the array of compartments of the supporting frame.

The porous membrane 14 is a microporous hydrophobic membrane that functions as an interface between the evaporative pads 12 and the surrounding air. This membrane layer featuring selectivity characteristics is impermeable to liquids and only allows vapor to pass through.

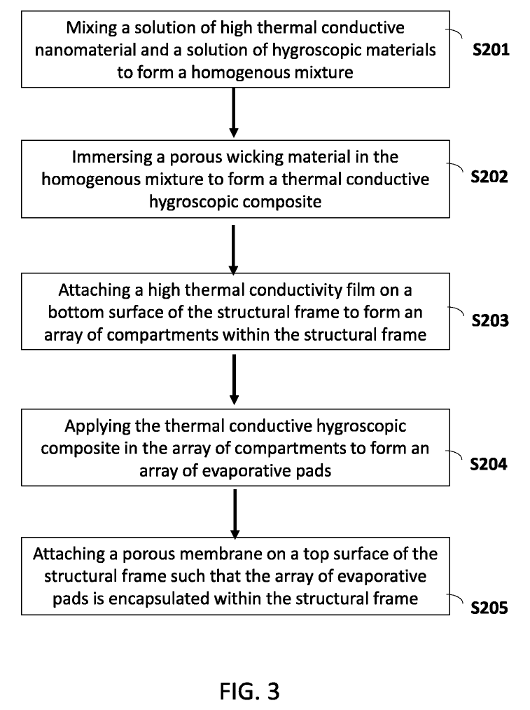

FIG. 3 illustrate a process flow of fabrication method of the adaptive flame-retardant cooling interface in accordance with one embodiment of the present invention. The method comprises the following steps:

S201: mixing a solution of high thermal conductive nanomaterial and a solution of hygroscopic materials to form a homogenous mixture via magnetic stirring for 12 hours;

S202: immersing a porous wicking material in the homogenous mixture for 12 hours to form a thermal conductive hygroscopic composite;

S203: attaching a high thermal conductive film on a bottom surface of the supporting frame to form an array of compartments within the supporting frame;

S204: applying the thermal conductive hygroscopic composite in the array of compartments within the supporting frame to form an array of evaporative pads;

S205: attaching a porous membrane on a top surface of the supporting frame such that the array of evaporative pads is encapsulated (or confined) within the supporting frame.

In step S203, the high thermal conductive film may be attached on the bottom surface of the supporting frame using thermal conductive double-sided adhesive tape; and

In step S205, the porous membrane may be attached on the top surface of the supporting frame using thermal conductive double-sided adhesive tape.

The anti-corrosion thermal conductive film 13 may be selected from, without limitation, a graphene film, a graphite sheet, a hexagonal boron nitride (h-BN) film, anticorrosion metal-based thin films, or composite films comprising polymer matrix loaded with thermally conductive fillers.

The supporting frame 11 may be made of copper with anti-corrosion graphene coating.

The evaporative pads 12 may adopt various geometric configurations. In representative designs, the layer may have a thickness of 2–10 mm and a compartment size of 20–100 mm. These values are provided as examples, and the geometry is not limited to the specific ranges recited herein.

The hygroscopic materials incorporated in the evaporative pads 12 may include, without limitation, metal-organic frameworks (MOFs), water–salt solutions such as LiBr, LiCl, CaCl₂, KBr, NaOH, or KOH, water–ionic liquid solutions such as [DMIM][DMP], [EMIM][Ac], [BMIM][BF₄], [BMIM][Br], [DMIM][Cl], or [EMIM][EtSO₄], other water–absorbent solutions, or any combination thereof.

The porous wicking material employed in the evaporative pads 12 may be selected from various hydrophilic or super-hydrophilic structures, including but not limited to activated carbon fiber, a super-hydrophilic expanded graphite matrix, or a super-hydrophilic carbon nanotube matrix.

The high thermal conductive nanomaterial incorporated in the evaporative pads 12 may be selected from graphene oxide, carbon nanotubes, metal oxides, nitrides, carbides, or other nanomaterials exhibiting high intrinsic thermal conductivity.

The porous membrane 14 may be made from, but is not limited to, polyethylene (PE), polypropylene (PP), polytetrafluoroethylene (PTFE), polyvinylidene fluoride (PVDF), or composites thereof, and other porous materials. In typical embodiments, the membrane exhibits a thickness in the range of 50 – 200 μm, a porosity between 0.4 and 0.8, and pore diameters of 0.2 – 2.0 μm.

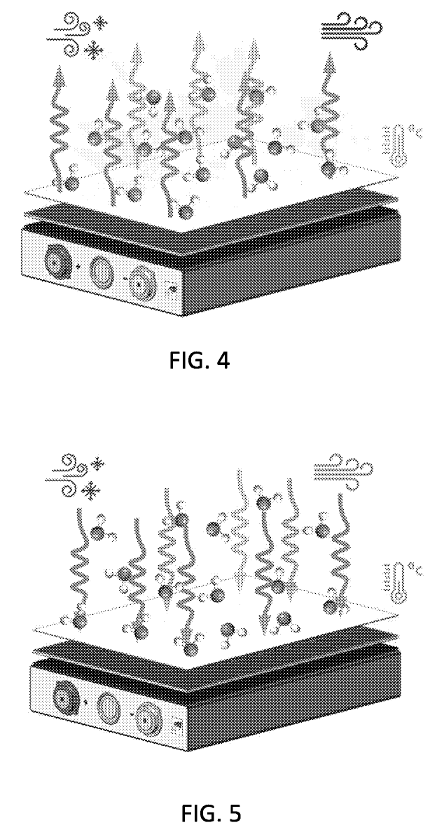

FIGS. 4 and 5 show the working principle of the adaptive flame-retardant cooling interface 10. When the LIB 20 operates with a high charging/discharging rate (FIG. 4), the waste heat generated by the LIB 20 is transferred to the evaporative pads 12 via the thermal conductive film 13 and the multi-compartment frame 11. It increases the hygroscopic material temperature and thus enhances the vapor pressure of the hygroscopic material in the evaporative pads 12. When the vapor pressure of the hygroscopic material is higher than that of the ambient air, water vapor is driven by the pressure difference to pass through the porous membrane and enter the air. This moisture desorption process provides high-flux cooling due to the large vaporization heat. As desorption continues, the LIB 20 gets cooled down and the hygroscopic material gets concentrated. Notably, the porous wicking material can effectively avoid non-uniform temperature distribution caused by reduced water. Doped high thermal conductive nanomaterial is conducive to forming a more efficient heat transfer network, improving the cooling performance of the cooling interface 10. Benefitting from the excellent flame retardancy of the porous wicking material, it can effectively prevent the thermal runaway propagation caused by extreme working conditions.

When the LIB 20 operates with a low charging/discharging rate or during off hours (FIG. 5), the LIB 20 maintains a low temperature. The concentrated hygroscopic material in the evaporative pads 12 holds a lower vapor pressure than the ambient air, which enables the water vapor to pass through the porous membrane 14 from the air to the hygroscopic material. This moisture absorption process regenerates the cooling capacity of the hygroscopic material (becomes diluted solution) for the next-cycle desorption cooling.

To demonstrate the performance of this invention, proof-of-concept experiments are conducted with a sample of cooling membrane. In the sample of cooling membrane, active carbon fiber was used as the porous wicking material; LiCl solution was used as the hygroscopic material; graphene oxide was used as the high thermal conductive nanomaterial; graphene film was used as the anti-corrosion thermal conductive film; the supporting frame was made of copper with anti-corrosion graphene coating; PTFE hydrophobic membrane was used as the porous membrane.

The cooling membrane (also referred to LiCl/GO@ACF membrane) was applied to a commercial 3.7 V/12 Ah nickel-cobalt-manganese LIB to evaluate the cooling performance of the invention.

Specifically, the LIB was wrapped by the LiCl/GO@ACF membrane and tested in the environment-controlled chamber with relative humidity (RH) of 60% and ambient temperature (T_{amb}) of 25° C. A thermocouple was mounted at the center of the LIB surface to monitor temperature changes.

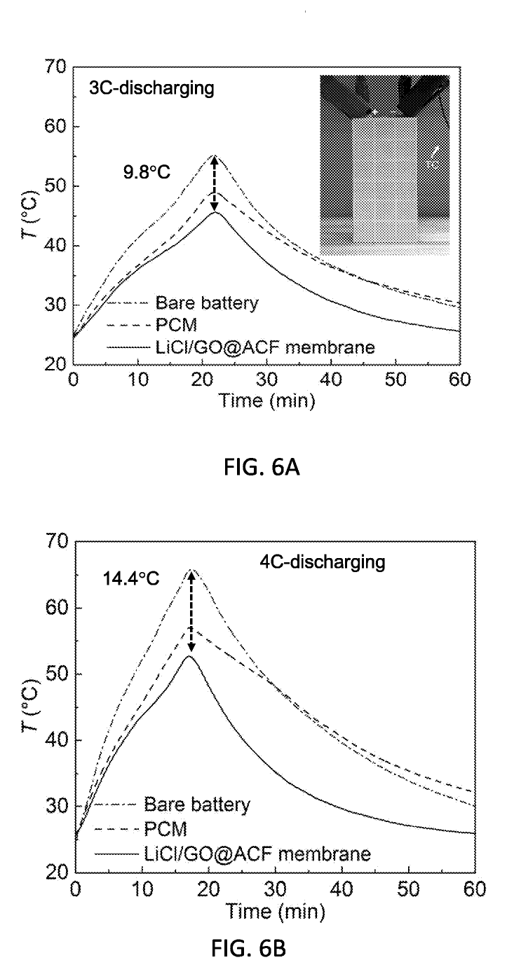

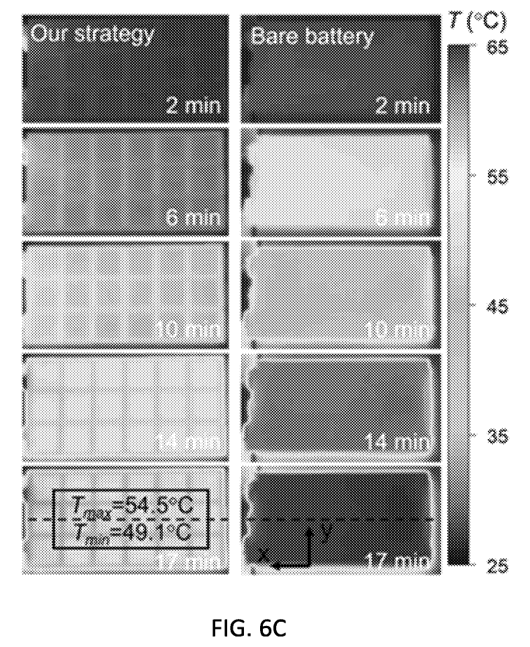

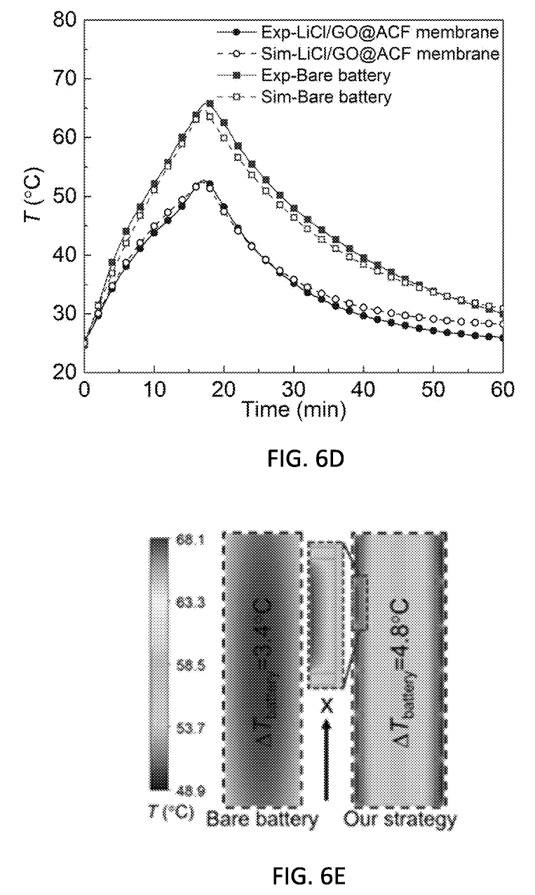

As shown in FIG. 6A, the LIB equipped with the LiCl/GO@ACF membrane shows a lower temperature compared to the bare LIB during the 3C discharging process, with a maximum temperature reduction of up to 9.8° C. At a discharging rate of 4C, the maximum temperature reduction reaches 14.4° C (FIG. 6B).

Additionally, the inventors compared the LiCl/GO@ACF membrane with cooling strategy using a phase change material (PCM), e.g., paraffin wax, to demonstrate the superiority of the proposed thermal management strategy. In FIGS. 6A and 6B, the maximum temperature reduction is up to 3.3° C and 4.3° C at a discharging rate of 3C and 4C, respectively, compared to the PCM cooling strategy. Meanwhile, the real-time temperature distribution of the LIB at the 4C discharging rate was visualized using an infrared (IR) camera (FIG. 6C). The water evaporation from the LiCl/GO@ACF membrane rapidly dissipates the heat generated by the LIB, resulting in lower temperatures in the LiCl/GO@ACF regions compared to the copper frame regions.

To analyze the internal temperature distribution of the LIB, the inventors developed the heat and mass transfer models of the LIB wrapped by the LiCl/GO@ACF membrane. The simulated temperature evolution of the LIB agrees well with the experimental result (FIG. 6D), indicating that the developed numerical model has high accuracy. According to the simulated temperature contours at the cross-section (FIG. 6E, black dashed lines in FIG. 6C), the maximum temperature difference of the LIB at the 4C discharging rate is 4.8° C (generally < 5° C). This result demonstrates that the proposed cooling strategy provides desirable temperature uniformity even at high charging/discharging rates. Notably, the optimal design configuration of the LiCl/GO@ACF membrane can be determined based on specific user requirements and operational conditions using the developed numerical model.

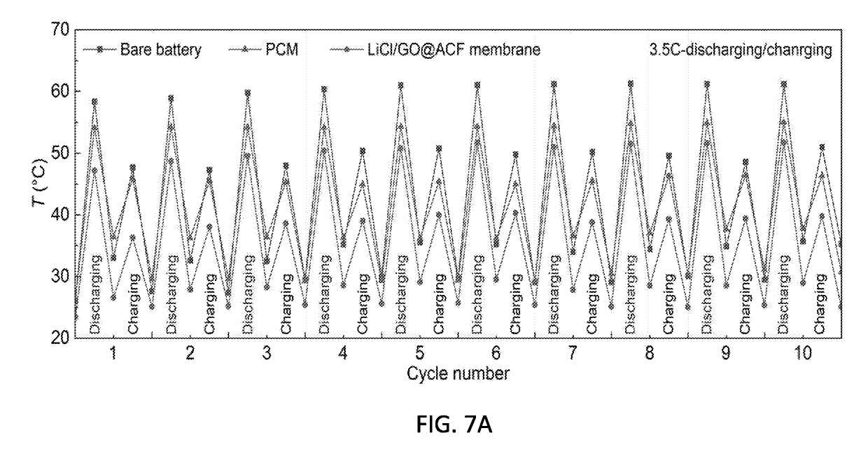

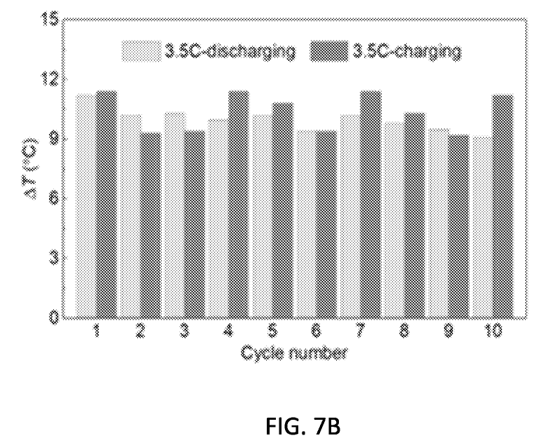

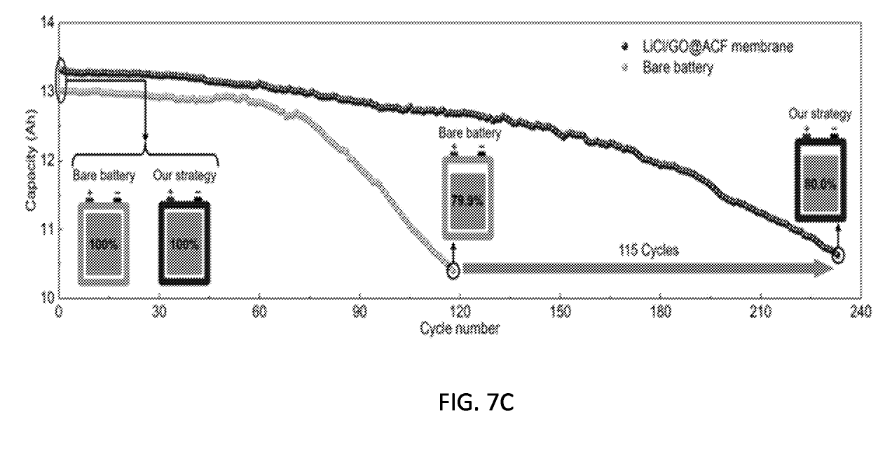

To evaluate the durability of the cooling performance of the LiCl/GO@ACF membrane, the inventors compared the temperature evolution of the batteries with and without LiCl/GO@ACF membrane at a high discharging-charging rate of 3.5C over 10 cycles, as depicted in FIG. 7A. The battery with the cooling membrane can always operate at a lower temperature compared to the bare battery and the battery with the PCM cooling strategy. The maximum temperature of the battery with the LiCl/GO@ACF membrane is only 52.1° C, within the acceptable temperature range for the battery. Notably, by maintaining the battery at the suitable operating temperature, the cooling membrane enables deeper charging and discharging cycles, suggesting that the proposed cooling strategy can extend the effective working time of batteries (e.g., enlarging the driving range for electric vehicles). Meanwhile, the peak temperature difference between the bare battery and the battery with the LiCl/GO@ACF membrane in each cycle is displayed in FIG. 7B. The temperature difference is maintained between 9.1° C and 11.4° C, further confirming the superior cooling performance of the proposed LiCl/GO@ACF membrane.

Most LIBs reach their end-of-life (EoL) points when the battery capacity deteriorates to 80% of its nominal capacity. The inventors evaluated the effect of the cooling membrane on the EoL point of LIBs at a cyclic discharging-charging rate of 4C. Considering safety concerns, the testing would be immediately interrupted once the battery temperature exceeded 75° C. As a result of FIG. 7C, the battery with the cooling membrane reaches its EoL point after 233 cycles without any solution leakage, while the bare battery lasts only 118 cycles. The cooling membrane significantly extends the LIB lifetime, contributing to a two-fold improvement while achieving an additional capacity of 1445.9 Ah. The remarkable performance improvement in the LIB demonstrates that the proposed cooling strategy is a highly promising candidate for enabling high-efficiency passive battery thermal management.

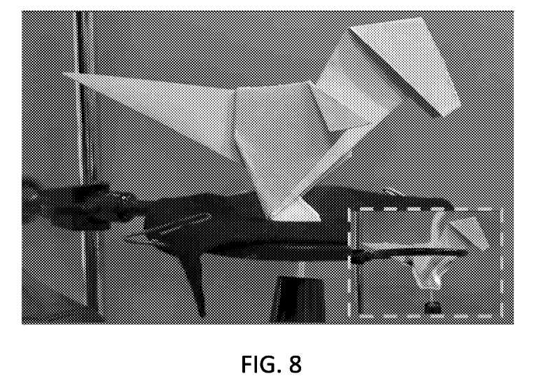

To evaluate the flame-retardant properties of the LiCl/GO@ACF, the inventors conducted burning experiments. A paper placed on the dried LiCl/GO@ACF could remain intact without any signs of combustion (FIG. 8), while the unprotected paper ignited and burned immediately (insert of FIG. 8). These results indicate that the proposed LiCl/GO@ACF can effectively prevent fire propagation caused by thermal runaway, thereby providing additional time to implement active control measures.

While the present disclosure has been described and illustrated with reference to specific embodiments thereof, these descriptions and illustrations are not limiting. The illustrations may not necessarily be drawn to scale. There may be distinctions between the illustrations in the present disclosure and the actual apparatus due to manufacturing processes and tolerances. There may be other embodiments of the present disclosure which are not specifically illustrated. Modifications may be made to adapt a particular situation, material, composition of matter, method, or process to the objective and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations.

What is claimed is:

1. An adaptive flame-retardant cooling interface, comprising:
a thermal conductive film;
a porous membrane; and
an array of evaporative pads accommodated respectively in an array of compartments of a supporting frame positioned between the thermal conductive film and the porous membrane; and
wherein:
the adaptive flame-retardant cooling interface is operable at a cooling state and a restoration state;
at the cooling state, the thermal conductive film is configurable to transfer heat from a heat source to the array of evaporative pads to increase water vapor pressure in the evaporation pads, and the array of evaporative pads is configurable to desorb water vapor out to ambient environment through the porous membrane; and
at the restoration state, the array of evaporative pads is configurable to adsorb water vapor from ambient environment through the porous membrane such that a cooling capacity of the adaptive flame-retardant cooling interface is restored.

2. The adaptive flame-retardant cooling interface according to claim 1, wherein the thermal conductive film is made of a graphene film, a graphite sheet, or a hexagonal boron nitride (h-BN) film.

3. The adaptive flame-retardant cooling interface according to claim 1, wherein the supporting frame is made of copper and has anti-corrosion graphene coating.

4. The adaptive flame-retardant cooling interface according to claim 1, wherein each evaporative pad is a mixture of a flame-retardant porous wicking material, a hygroscopic material and a high thermal conductive nanomaterial.

5. The adaptive flame-retardant cooling interface according to claim 4, wherein the porous wicking material is active carbon fiber.

6. The adaptive flame-retardant cooling interface according to claim 4, wherein the hygroscopic material is a metal-organic framework, a water–salt solution, or a water–ionic liquid solution.

7. The adaptive flame-retardant cooling interface according to claim 4, wherein the high thermal conductive nanomaterial is made of a graphene oxide, carbon nanotubes, a metal oxide, a metal nitride, or a metal carbide.

8. The adaptive flame-retardant cooling interface according to claim 1, wherein the porous membrane is made of polyethylene (PE), polypropylene (PP), polytetrafluoroethylene (PTFE), polyvinylidene fluoride (PVDF), or combinations thereof.

9. A method for fabricating the adaptive flame-retardant cooling interface of claim 1, comprising:
mixing a solution of high thermal conductive nanomaterial and a solution of hygroscopic materials to form a homogenous mixture via magnetic stirring;
immersing a porous wicking material in the homogenous mixture to form a thermal conductive hygroscopic composite;
attaching a high thermal conductive film on a bottom surface of the supporting frame to form an array of compartments within the supporting frame;
applying the thermal conductive hygroscopic composite in the array of compartments within the supporting frame to form an array of evaporative pads; and
attaching a porous membrane on a top surface of the supporting frame such that the array of evaporative pads is encapsulated within the supporting frame.

10. The method according to claim 9, wherein the thermal conductive film is a graphene film.

11. The method according to claim 9, wherein the supporting frame is made of copper and has anti-corrosion graphene coating.

12. The method according to claim 9, wherein each evaporative pad is a mixture of a flame-retardant porous wicking material, a hygroscopic material and a high thermal conductive nanomaterial.

13. The method according to claim 12, wherein the porous wicking material is active carbon fiber.

14. The method according to claim 12, wherein the hygroscopic material is a metal-organic framework, a water–salt solution, or a water–ionic liquid solution.

15. The method according to claim 12, wherein the high thermal conductive nanomaterial is made of a graphene oxide, carbon nanotubes, a metal oxide, a metal nitride, or a metal carbide.

16. The method according to claim 9, wherein the porous membrane is made of polyethylene (PE), polypropylene (PP), polytetrafluoroethylene (PTFE), polyvinylidene fluoride (PVDF), or combinations thereof.
